(19) United States
(12) Patent Application Publication
(10) Pub. No.: US 2005/0232090 A1
(43) Pub. Date: Oct. 20, 2005

(54) Apparatus and setup method for reproducing information recorded in optical recording medium, and computer product

(75) Inventors: Hiroyuki Matsumoto, Kawagoe-shi (JP); Takeshi Matsumoto, Kawagoe-shi (JP); Katsunori Tamamura, Kawagoe-shi (JP); Takao Yoshida, Kawagoe-shi (JP); Fumito Inaba, Kawagoe-shi (JP)

Correspondence Address: FOLEY AND LARDNER;SUITE 500, 3000 K STREET NW, WASHINGTON, DC, 20007, US

(73) Assignee: PIONEER CORPORATION

(21) Appl. No.: 11/085,249

(22) Filed: Mar. 22, 2005

(30) Foreign Application Priority Data
Mar. 25, 2004 (JP) 2004-089643

(51) Int. Cl. G11B 7/085

(52) U.S. Cl. 369/30.1

(57) ABSTRACT

An apparatus for reproducing an optical recording medium includes a system controller. The system controller causes a reproduction processor to first execute an initial setup process of reading out audio data from a disk and then to execute a reproduction process. When digital audio data is accumulated in a shockproof memory, the system controller causes the reproduction processor to suspend reading of the audio data from the disk and execute an automatic adjustment process. After the automatic adjustment process is finished, the reproduction processor resumes the reading of the audio data from the disk using adjustment values acquired through the automatic adjustment process executed.

### BACKGROUND OF THE INVENTION

1) Field of the Invention

The present invention relates to a technology for reproducing information recorded on an optical recording medium.

2) Description of the Related Art

Optical-recording-medium reproducing apparatuses reproduce information recorded on an optical recording medium (hereinafter, “disk”) such as a laser disk, a compact disk, and a Digital Versatile Disk (DVD). To accurately read information from the disk, it is necessary to adjust a rotational speed of the disk, positions of an optical pickup and a track of the disk, and focus of a lens in the optical pickup, and to optimize a spot of a laser beam irradiated from the optical pickup onto the disk. In the optical-recording-medium reproducing apparatus, the rotational speed of the disk and the position of the optical pickup, and the position of the lens in the optical pickup are controlled by servo control. Therefore, when reproducing information on the disk, the optical-recording-medium reproducing apparatus executes a process of adjusting a signal used for the servo control over a target disk (tracking error signal and focus error signal), to an appropriate value. More specifically, the optical-recording-medium reproducing apparatus executes focus system adjustments (focus offset adjustment, focus balance adjustment, focus Automatic Gain Control (AGC) adjustment, focus bias adjustment, and focus gain-up), tracking system adjustments (tracking offset adjustment, tracking balance adjustment, tracking AGC adjustment, and tracking gain-up), and Radio Frequency (RF) system adjustments (RF offset adjustment, RFAGC adjustment, and RF gain-up). Then, the optical-recording-medium reproducing apparatus reads out information from the disk. In other words, various adjustment processes (automatic adjustment processes) are performed as a setup process of reproducing the disk.

However, if the information recorded on the disk is, for example, audio data, the setup process including the various adjustment processes is performed in response to a reproduction instruction, and then audio data is read out and outputted. A problem is that, if these processes are performed, it takes time from when a listener gives the reproduction instruction until sound is actually outputted.

In order to resolve the problem, Japanese Patent Application Laid-Open No. Hei 7-141666 discloses a technology for an automatic gain adjustment device. More specifically, upon adjustment of a focus servo and gain adjustment of a tracking servo, the automatic gain adjustment device performs stable gain adjustment, with less misadjustment due to variations of a lens position. Moreover, the automatic gain adjustment device stores gain adjustment values obtained through the gain adjustment, and reproduces information using the gain adjustment values stored upon replay unless a disk is unloaded.

If an optical-recording-medium reproducing apparatus includes the conventional automatic gain adjustment device, the time becomes shorter from receiving a replay instruction till outputting sound. In this optical-recording-medium reproducing apparatus, once the optical-recording-medium reproducing apparatus performs automatic adjustment before replaying a disk, the optical-recording-medium reproducing apparatus performs a replay using automatic adjustment values stored unless the disk is unloaded.

In the conventional technology, however, the automatic adjustment is performed only once when the disk is inserted thereinto, and therefore, some problems may occur. For example, the conventional technology cannot deal with changes in state such as soil of a lens, and deterioration, which may be caused during a period from insertion of the disk to ejection (detachment) thereof. In other words, replay is performed using the automatic adjustment values obtained when the disk is inserted. Therefore, if the state is changed after the automatic adjustment, the automatic adjustment becomes inappropriate, but information is read out from the disk in the state of inappropriate adjustment. Because of this, if the information cannot be read out upon replay, the automatic adjustment has to be performed again, and therefore, it takes time from receiving a replay instruction till outputting sound.

### SUMMARY OF THE INVENTION

It is an object of the present invention to solve at least the problems in the conventional technology.

According to one aspect of the present invention, an apparatus for reproducing audio data recorded in an optical recording medium includes an optical pickup, a storage unit, a reproduction processor, a system controller, and a reproducing unit. The optical pickup reads out the audio data from the optical recording medium. The storage unit accumulates at least one of a plurality of first digital audio signals obtained by performing a demodulation process on the audio data read-out. The reproduction processor executes a reproduction process with respect to the audio data, the reproduction process including performing the demodulation process on the audio data, generating a second digital audio signal, which is to be stored in the storage unit, from the audio data at a speed faster than a speed at which the first digital audio signal is outputted from the storage unit, and outputting the first digital audio signal from the storage unit. The system controller causes the reproduction processor, when receiving a reproduction instruction, to execute an initial setup process and then starts the reproduction process, causes the reproduction processor, when a predetermined amount of the first digital audio signals is accumulated in the storage unit, to suspend generation of the second digital audio signal and execute an automatic adjustment process, releases suspending the generation of the second digital audio signal when the automatic adjustment process is finished, and causes the reproduction processor to resume the reproduction process. The reproducing unit that reproduces audio data based on the first digital audio signal.

According to another aspect of the present invention, when an apparatus for reproducing audio data recorded in an optical recording medium, the apparatus includes an optical pick up that reads out audio data from an optical recording medium using a laser beam, a storage unit that accumulates at least one of a plurality of first digital audio signals obtained by performing a demodulation process on the audio data read-out, the setup method including executing a reproduction operation that includes performing the demodulation process on the audio data, generating a second digital audio signal, which is to be stored in the storing unit, from the audio data at a speed faster than a speed at which the first digital audio signal is outputted from the storage unit, and outputting the first digital audio signal from the storage unit, a setup method for the apparatus includes executing an initial setup process when a reproduction instruction is received; executing the reproduction operation after the initial setup process is finished; suspending the generating the second digital audio signal when a predetermined amount of the first digital audio signals is accumulated in the storage unit, and executing an automatic adjustment process for components of the optical-recording-medium reproducing apparatus; and releasing the suspending when the automatic adjustment process is finished, and resuming the reproduction process.

According to still another aspect of the present invention, a computer-readable recoding medium that stores therein a computer program that implements the above method on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an optical-recording-medium reproducing apparatus according to the present invention;

FIG. 2 is a block diagram of a system controller of FIG. 1;

FIG. 3 is a flowchart for explaining operation of the optical-recording-medium reproducing apparatus;

FIG. 4 is a diagram of a time relation between process in the optical-recording-medium reproducing apparatus and digital audio signals stored in a shockproof memory; and

FIG. 5 is a diagram of another time relation between process when automatic adjustment is executed before sound output starts and digital audio signals stored in the shockproof memory.

### DETAILED DESCRIPTION

Exemplary embodiments of the present invention are explained in detail below with reference to the accompanying drawings.

Optical-recording-medium reproducing apparatuses, which reproduce a disk with audio data recorded thereon, usually include a shockproof memory to prevent a dropout. The optical-recording-medium reproducing apparatus including the shockproof memory reads out audio data from the disk at a speed faster than a speed at which audio data is reproduced, for example, a speed twice as fast as the speed at which the audio data is reproduced. The optical-recording-medium reproducing apparatus performs a predetermined process on the audio data read-out so as to generate a digital audio signal, accumulates the digital audio signal in the shockproof memory, and outputs the digital audio signal accumulated in the shockproof memory. In other words, the audio data is pre-read out from the disk, and digital audio signals for a predetermined time, which follow digital audio signals currently outputted, are accumulated in the shockproof memory. With this accumulation, even if an error occurs in reading from the disk due to a shock and the like, a dropout is prevented since the digital audio signals accumulated in the shockproof memory are outputted.

The present invention is achieved by focusing attention on that the digital audio signals for a predetermined time are accumulated in the shockproof memory. In the present invention, a minimum initial setup process required for reproduction is performed in response to a reproduction instruction, and a reproduction process is executed. After the digital audio signals are accumulated in the shockproof memory, it is suspended to read audio data from the disk, and various adjustment processes are executed. The adjustment processes are automatic adjustment processes such as focus offset adjustment, focus balance adjustment, focus automatic gain control adjustment, focus bias adjustment, focus gain-up, tracking offset adjustment, tracking balance adjustment, tracking automatic gain adjustment, tracking gain-up, RF offset adjustment, RF automatic gain adjustment, and RF gain-up adjustment.

More specifically, in the present invention, before a predetermined amount of digital audio signals is accumulated in the shockproof memory, audio data is read out from the disk using adjustment values obtained when the reproduction process is last executed. After the predetermined amount of digital audio signals is accumulated in the shockproof memory, the various adjustment processes are executed. Then, after the various adjustment processes are finished, audio data is read out from the disk using adjustment values obtained through the various adjustment processes. Therefore, the time from reception of the reproduction instruction to output of sound reduces, and audio data is read out from the disk using appropriate adjustment values.

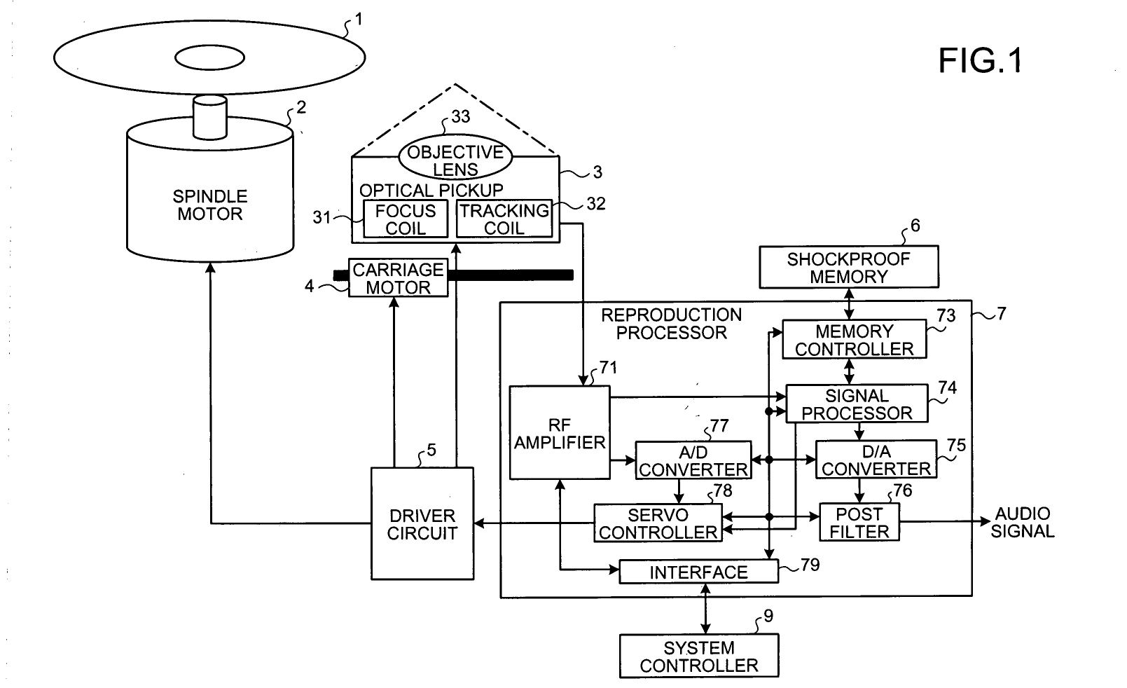

An embodiment of the present invention is explained below with reference to FIG. 1 to FIG. 5. FIG. 1 is a schematic of an optical-recording-medium reproducing apparatus according to the embodiment of the present invention. The optical-recording-medium reproducing apparatus includes a spindle motor 2, an optical pickup 3, a carriage motor 4, a reproduction processor 7, a driver circuit 5, a shockproof memory 6, and a system controller 9. The spindle motor 2 rotates a disk 1, the optical pickup 3 irradiates a laser beam on the disk 1 and reads out information from the disk 1, and the carriage motor 4 drives the optical pickup 3 in a tracking direction of the disk 1 (a diametric direction of the disk 1). The reproduction processor 7 generates a digital audio signal based on audio data read-out from the disk 1 by the optical pickup 3, outputs the digital audio signal generated, and generates various servo signals for driving a focus coil 31 and a tracking coil 32 in the optical pickup 3, the carriage motor 4, and the spindle motor 2 by servo control. The driver circuit 5 amplifies a current of each servo signal generated by the reproduction processor 7 and outputs drive signals for driving the focus coil 31, the tracking coil 32, the carriage motor 4, and the spindle motor 2. The shockproof memory 6 (which corresponds to a storage unit in claims) temporarily stores the digital audio signal generated by the reproduction processor 7, and the system controller 9 integrally controls the optical-recording-medium reproducing apparatus.

The optical pickup 3 includes a semiconductor laser (not shown) that serves as a light source of a laser beam, an objective lens 33 for an optical system, a liquid crystal panel (not shown), an optical detector (not shown) that detects light reflected from the disk 1, the focus coil 31, and the tracking coil 32. In the optical pickup 3, the light source emits a laser beam, the laser beam is irradiated on the disk 1 through the liquid crystal panel and the objective lens 33, the optical detector detects the light reflected from the disk 1, the light reflected is converted to an electrical signal, and the electrical signal is outputted to an RF amplifier 71 of the reproduction processor 7.

The focus coil 31 drives the objective lens 33 according to a focus drive signal inputted from the driver circuit 5, and focuses the laser beam to be irradiated on the disk 1. The tracking coil 32 drives the objective lens 33 in the tracking direction of the disk 1 according to a tracking drive signal inputted from the driver circuit 5.

The reproduction processor 7 includes the RF amplifier 71, a signal processor 74, a memory controller 73, a digital-to-analog (D/A) converter 75, a post filter 76, an analog-to-digital (A/D) converter 77, a servo controller 78, and an interface 79.

The RF amplifier 71 performs operation and amplification on electrical signals inputted from the optical pickup 3, and generates an RF signal, a focus error signal, and a tracking error signal from the electrical signals operated and amplified. The RF amplifier 71 binarizes the RF signal generated and outputs the RF signal binarized to the signal processor 74. Furthermore, the RF amplifier 71 outputs the focus error signal and the tracking error signal generated to the A/D converter 77.

The signal processor 74 generates a Constant Linear Velocity (CLV) error signal used for constant linear velocity of the spindle motor 2 according to the RF signal binarized, and outputs the CLV error signal to the servo controller 78. The signal processor 74 performs an Eight-to-Fourteen Modulation (EFM) demodulation process on the RF signal binarized, and performs an error-correction demodulation process and the like on a demodulation signal using Cross Interleave Reed-Solomon Code (CIRC) so as to generate a digital audio signal. The signal processor 74 outputs the digital audio signal generated to the memory controller 73, and outputs the digital audio signal inputted from the memory controller 73 to the D/A converter 75.

The memory controller 73 includes a function of controlling access to the shockproof memory 6, stores the digital audio signal inputted from the signal processor 74 in the shockproof memory 6, reads out the digital audio signal stored from the shockproof memory 6, and outputs the digital audio signal read-out to the signal processor 74.

The D/A converter 75 converts the digital audio signal inputted from the signal processor 74 to an analog audio signal, and outputs the analog audio signal obtained through conversion to the post filter 76. The post filter 76 removes a noise component from the analog audio signal, and outputs an audio signal in an audio frequency band.

The A/D converter 77 converts an analog focus error signal and an analog tracking error signal inputted from the RF amplifier 71 to digital values, and outputs a digital focus error signal and a digital tracking error signal to the servo controller 78.

The servo controller 78 generates a spindle servo signal based on the CLV error signal. The servo controller 78 generates a carriage servo signal for driving the carriage motor 4 and a tracking servo signal for driving the tracking coil 32 based on the tracking error signal. The servo controller 78 generates a focus servo signal for driving the focus coil 31 based on the focus error signal. The servo controller 78 outputs the spindle servo signal, the carriage servo signal, the tracking servo signal, and the focus servo signal to the driver circuit 5.

The servo controller 78 superposes a turbulence signal on the focus error signal and the tracking error signal upon execution of various adjustment processes, drives the focus coil 31 and the tracking coil 32, and outputs adjustment values obtained by the various adjustment processes to the system controller 9 through the interface 79.

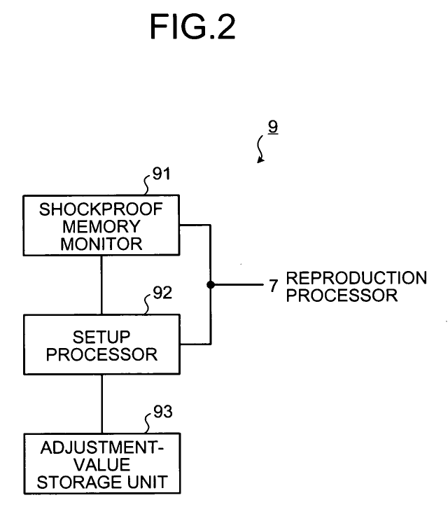

FIG. 2 is a block diagram of the system controller 9 of FIG. 1. The system controller 9 includes a shockproof memory monitor 91, a setup processor 92, and an adjustment-value storage unit 93. The adjustment-value storage unit 93 stores adjustment values obtained when the various adjustment processes are executed.

The shockproof memory monitor 91 accesses the memory controller 73 through the interface 79 and monitors how the shockproof memory 6 is used, i.e., an accumulation amount of digital audio signals stored in the shockproof memory 6.

The setup processor 92 sets various adjustment values that are stored in the adjustment-value storage unit 93, in the RF amplifier 71 and the servo controller 78 when the disk 1 is inserted into the optical-recording-medium reproducing apparatus or a reproduction instruction is received. The setup processor 92 also instructs the servo controller 78 to close the spindle servo, the carriage servo, the tracking servo, and the focus servo. Furthermore, the setup processor 92 notifies the servo controller 78 of starting the various adjustment processes based on the result of monitoring by the shockproof memory monitor 91.

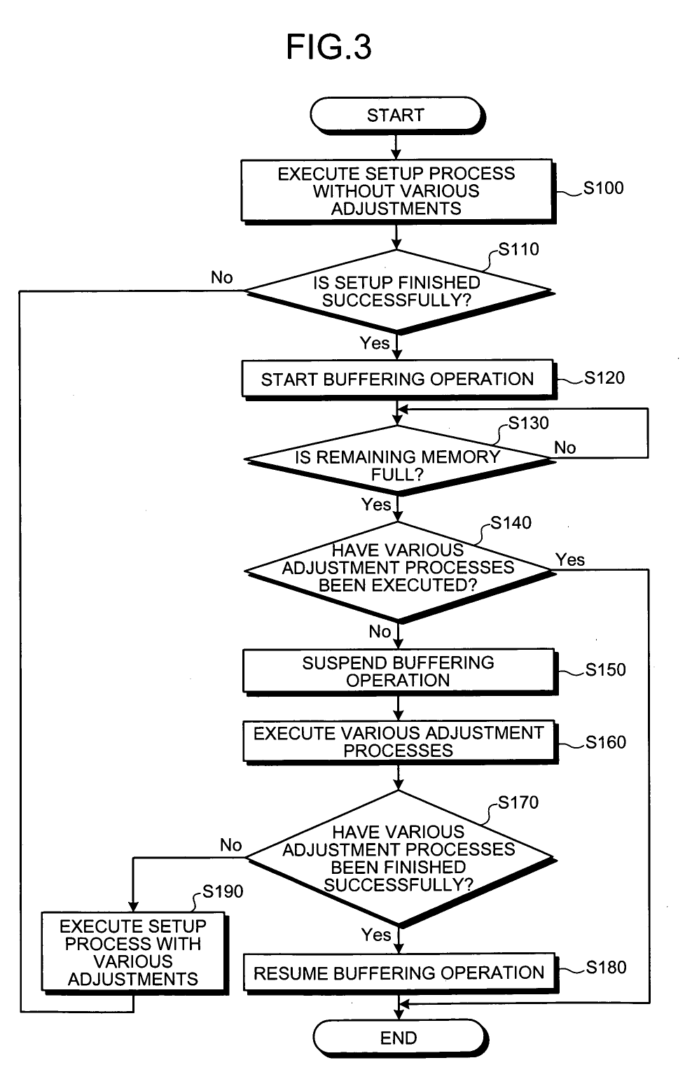

Operation of the optical-recording-medium reproducing apparatus according to the embodiment of the present invention is explained below with reference to a flowchart of FIG. 3. It is noted that adjustment values acquired when the various adjustment processes are last executed or initial values are set in the adjustment-value storage unit 93.

When detecting that the disk 1 is inserted into the optical-recording-medium reproducing apparatus or that an instruction to reproduce the disk 1 is received, the setup processor 92 executes a minimum initial setup process (initial setup process without automatic adjustment) without execution of the various adjustment processes (step S100). More specifically, the setup processor 92 reads out the various adjustment values stored in the adjustment-value storage unit 93 and sets the various adjustment values read-out in the RF amplifier 71 and the servo controller 78, and instructs the servo controller 78 to close the spindle servo, the carriage servo, the tracking servo, and the focus servo. The servo controller 78 closes the spindle servo, the carriage servo, the tracking servo, and the focus servo.

When the initial setup process without automatic adjustment is successfully finished, the setup processor 92 operates the components of the reproduction processor 7, and causes them to start a buffering operation of reading out audio data recorded on the disk 1 and storing it in the shockproof memory 6 (step S120). More specifically, the setup processor 92 instructs the components of the reproduction processor 7 to perform the reproduction process. With this instruction, the servo controller 78 outputs the spindle servo signal, the carriage servo signal, the tracking servo signal, and the focus servo signal to make the spindle motor 2 rotate through the driver circuit 5. Furthermore, the servo controller 78 moves the optical pickup 3 to a predetermined position of the disk 1 by the carriage motor 4, and starts reading the audio data recorded on the disk 1.

The RF amplifier 71 generates an RF signal from the signal inputted from the optical pickup 3. The signal processor 74 performs the EFM demodulation process on the RF signal so as to generate a demodulation signal, and performs the error-correction demodulation process or the like on the demodulation signal using the CIRC so as to generate a digital audio signal.

The memory controller 73 stores the digital audio signal generated in the shockproof memory 6 and reads out the digital audio signal generated from the shockproof memory 6, and the D/A converter 75 converts the digital audio signal to an analog audio signal. The post filter 76 removes a noise component from the analog audio signal, and outputs the analog audio signal without the noise component, and sound output is started so that a listener can listen to it.

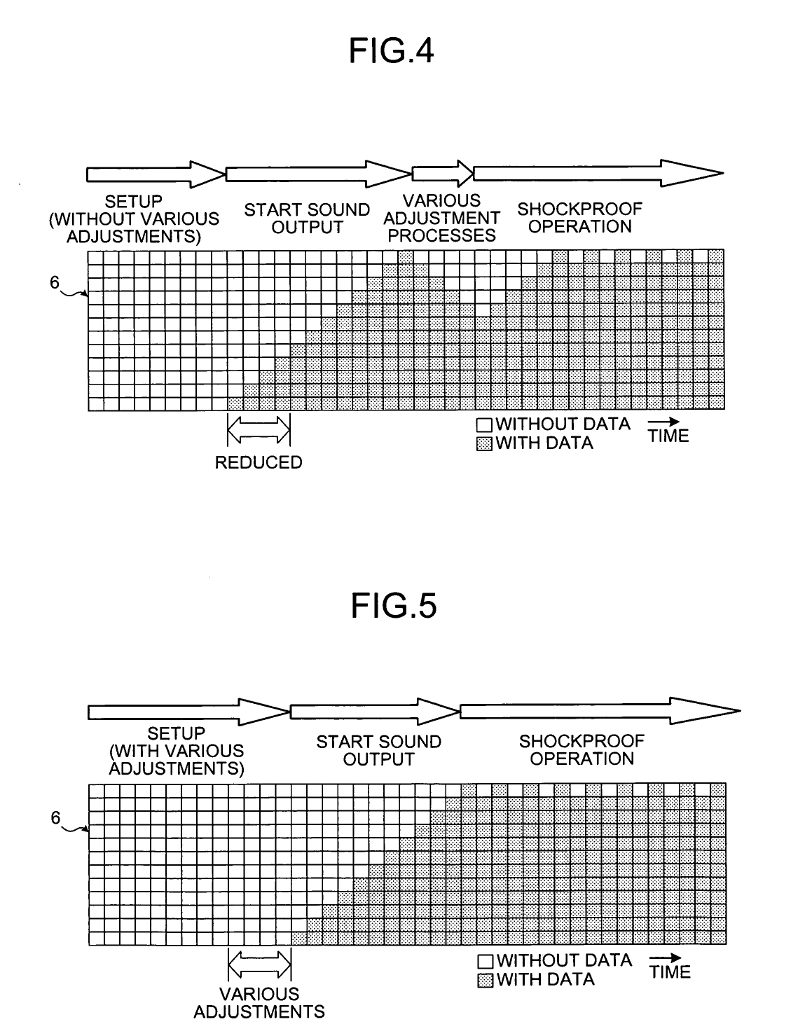

The servo controller 78 controls the rotational speed of the spindle motor 2 so as to read out audio data from the disk 1 at a speed, for example, twice as fast as a speed at which the digital audio signal is outputted. Therefore, as shown in FIG. 4, when the sound output is started after the initial setup process without automatic adjustment is finished, the digital audio signal is accumulated in the shockproof memory 6 with the passage of time.

The shockproof memory monitor 91 accesses the memory controller 73 through the interface 79 and monitors the accumulation amount of the digital audio signals stored in the shockproof memory 6 (step S130). When detecting that the digital audio signals are stored in the entire storage area of the shockproof memory 6 (the shockproof memory 6 is full), the shockproof memory monitor 91 notifies the setup processor 92 of a message that the shockproof memory 6 becomes full.

When receiving the message, the setup processor 92 determines whether the adjustment processes have been executed to the disk 1 that is currently reproduced (step S140). It is determined whether the adjustment processes have been executed, according to a state of an adjustment flag. The state of the adjustment flag is such that an adjustment execution flag indicating adjustment information is previously stored in the adjustment-value storage unit 93, the adjustment execution flag is cleared when the initial setup process without automatic adjustment is executed, and the adjustment flag is set after execution of the adjustment processes. If the adjustment processes have already been executed (when the adjustment flag is set), the setup processor 92 finishes the process because the adjustment processes have been executed to the disk 1.

If the adjustment processes have not been executed (when the adjustment flag is cleared), the setup processor 92 notifies the memory controller 73, through the interface 79, of suspension of the buffering operation of storing the digital audio signals in the shockproof memory 6 (step S150).

When receiving the notification, the memory controller 73 stops the operation of storing the digital audio signals inputted from the signal processor 74 in the shockproof memory 6, and continues only the operation of reading the digital audio signals stored from the shockproof memory 6. That is, the memory controller 73 suspends the storage of the digital audio signals, reads out the digital audio signal that is pre-read out from the disk 1 and stored in the shockproof memory 6, and continues sound output.

The setup processor 92 notifies the servo controller 78 of starting of the adjustment processes. When receiving the notification, the servo controller 78 executes the adjustment processes (step S160). More specifically, the servo controller 78 executes the various adjustment processes such as the focus offset adjustment, the focus balance adjustment, the focus AGC adjustment, the focus bias adjustment, the focus gain-up, the tracking offset adjustment, the tracking balance adjustment, the tracking AGC adjustment, the tracking gain-up, the RF offset adjustment, the RFAGC adjustment, and the RF gain-up. When these adjustment processes are finished, the servo controller 78 notifies the setup processor 92, through the interface 79, of these adjustment values acquired through the adjustment processes.

The setup processor 92 determines whether the adjustment processes are finished successfully (step S170). If the adjustment processes are finished successfully, the setup processor 92 notifies the memory controller 73, through the interface 79, of resumption of the buffering of storing the digital audio signals in the shockproof memory 6 (step S180). The setup processor 92 also notifies the servo controller 78 of resumption of the reproduction process. The servo controller 78 first outputs the spindle servo signal, the carriage servo signal. the tracking servo signal, and the focus servo signal. Then, the servo controller 78 causes the spindle motor 2 to rotate through the driver circuit 5 and causes the carriage motor 4 to moves the optical pickup 3 to a position where the reading of information from the disk 1 has been suspended (a track position on the disk 1 before the adjustment processes are executed), and resumes the reading of the audio signal recorded on the disk 1. With these operations, using the adjustment values obtained through the adjustment processes, the optical pickup 3 reads out the audio data from the disk 1, and the RF amplifier 71 generates an RF signal from the signal inputted from the optical pickup 3. The signal processor 74 performs the EFM demodulation process on the RF signal so as to generate a demodulation signal, and performs the error-correction demodulation process and the like on the demodulation signal using the CIRC so as to generate a digital audio signal.

When receiving the notification of resumption of the buffering operation, the memory controller 73 resumes the buffering operation of storing the digital audio signal inputted from the signal processor 74 in the shockproof memory 6 (step S180).

If the initial setup process without automatic adjustment or the adjustment processes are not finished successfully, the setup processor 92 causes the servo controller 78 to execute the setup process including the various adjustment processes (step S190). More specifically, the servo controller 78 closes the spindle servo, the carriage servo, the tracking servo, and the focus servo, and then executes the adjustment processes.

FIG. 4 is a diagram of a time relation between processes in the optical-recording-medium reproducing apparatus and digital audio signals stored in the shockproof memory 6. FIG. 5 is a diagram of another time relation between processes and digital audio signals stored in the shockproof memory 6 when the reproduction process is executed after the setup process with automatic adjustment is executed in response to an instruction to reproduce the disk 1.

As shown in FIG. 4, the optical-recording-medium reproducing apparatus executes the initial setup process without automatic adjustment, starts reading of audio data from the disk 1 to start sound output, and performs adjustment processes after digital audio signals are accumulated in the shockproof memory 6. Therefore, as compared with the case where the automatic adjustment is executed before starting of sound output as shown in FIG. 5 (the case where the conventional setup process is executed), the time for starting sound output reduces by the process time required for the automatic adjustment.

In the embodiment, as explained above, the setup processor 92 causes the reproduction processor 7 to execute the minimum initial setup process required for reading out audio data from the disk 1 and to execute the reproduction process using the adjustment values stored in the adjustment-value storage unit 93. When the shockproof memory monitor 91 detects that digital audio data (the digital audio signals) is accumulated in the shockproof memory 6 by the reproduction process, the setup processor 92 causes the reproduction processor 7 to suspend reading of audio data from the disk 1 and execute the various adjustment processes. After the various adjustment processes are finished, the reproduction processor 7 resumes the reading of the audio data from the disk 1 using the adjustment values acquired through the various adjustment processes executed. With these operations, it is possible to reduce the time from reception of the reproduction instruction to output of sound and to read out audio data from the disk using appropriate adjustment values.

In the embodiment, while the digital audio signals are being output from the shockproof memory 6, i.e., during reproduction of sound such as music, the various adjustment processes are executed. Therefore, noise during AGC adjustment occurring by the focus coil 31 and the tracking coil 32 (actuator) becomes negligible due to the sound being reproduced.

In the embodiment, when the digital audio signals are accumulated in the shockproof memory 6, the various adjustment processes are executed at a time, but the adjustment processes may be executed plural times.

In the embodiment, when detecting that the disk 1 is inserted into the optical-recording-medium reproducing apparatus or that the instruction to reproduce the disk 1 is received, the initial setup process is executed to start the reproduction process. If the digital audio signals are stored fully in the shockproof memory 6, then the various adjustment processes are executed. However, when the disk 1 is inserted into the optical-recording-medium reproducing apparatus, the setup process including the various adjustment processes may be executed in the conventional manner, and when it is detected that the reproduction instruction (replay) is received, the setup process may be executed to start the reproduction process. Furthermore, if the digital audio signals are stored fully in the shockproof memory 6, then the various adjustment processes may be executed.

The reproduction processor 7 is generally controlled by a Central Processing Unit (CPU) in many cases. The functions to be performed by the shockproof memory monitor 91 and the setup processor 92 may be realized by software and may be executed by the CPU that controls the reproduction processor 7.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An apparatus for reproducing audio data recorded in an optical recording medium, the apparatus comprising:
an optical pickup that reads out the audio data from the optical recording medium;
a storage unit that accumulates at least one of a plurality of first digital audio signals obtained by performing a demodulation process on the audio data read-out;
a reproduction processor that executes a reproduction process with respect to the audio data, the reproduction process including performing the demodulation process on the audio data, generating a second digital audio signal, which is to be stored in the storage unit, from the audio data at a speed faster than a speed at which the first digital audio signal is outputted from the storage unit, and outputting the first digital audio signal from the storage unit;
a system controller that
causes the reproduction processor, when receiving a reproduction instruction, to execute an initial setup process and then starts the reproduction process,
causes the reproduction processor, when a predetermined amount of the first digital audio signals is accumulated in the storage unit, to suspend generation of the second digital audio signal and execute an automatic adjustment process,
releases suspending the generation of the second digital audio signal when the automatic adjustment process is finished, and
causes the reproduction processor to resume the reproduction process; and
a reproducing unit that reproduces audio data based on the first digital audio signal.

2. The apparatus according to claim 1, wherein
the system controller includes
an adjustment-value storage unit that stores adjustment values acquired when the reproduction processor executes the automatic adjustment process;
a monitoring unit that monitors an accumulation amount of the first digital audio signals stored in the storage unit; and
a setup processor that causes the reproduction processor to execute the initial setup process, the reproduction process, and the automatic adjustment process,
when the reproduction process is to be executed after the initial setup process is finished, the setup processor causes the reproduction processor to execute the reproduction process using the adjustment values stored in the adjustment value storage unit, and
when the generation of the second digital audio signal for the reproduction process is to be resumed after the automatic adjustment process is finished, the setup processor causes the reproduction processor to execute the reproduction process using adjustment values acquired through the automatic adjustment process.

3. The apparatus according to claim 1, wherein the automatic adjustment process includes a process of adjusting a servo control signal for controlling a position of an objective lens of the optical pickup.

4. The apparatus according to claim 1, wherein the automatic adjustment process includes a process of adjusting a signal of the audio data read-out by the optical pickup.

5. The apparatus according to claim 1, wherein the automatic adjustment process includes
a first process of adjusting a servo control signal for controlling a position of an objective lens of the optical pickup; and
a second process of adjusting a signal of the audio data read-out by the optical pickup.

6. The apparatus according to claim 3, wherein the process includes at least one of focus offset adjustment, focus balance adjustment, focus automatic gain control adjustment, focus bias adjustment, focus gain-up, tracking offset adjustment, tracking balance adjustment, tracking automatic gain adjustment, and tracking gain-up.

7. The apparatus according to claim 4, wherein the process includes at least one of radio frequency offset adjustment, radio frequency automatic gain adjustment, and radio frequency gain-up adjustment.

8. The apparatus according to claim 5, wherein
the first process includes at least one of focus offset adjustment, focus balance adjustment, focus automatic gain control adjustment, focus bias adjustment, focus gain-up, tracking offset adjustment, tracking balance adjustment, tracking automatic gain adjustment, and tracking gain-up, and
the second process includes at least one of radio frequency offset adjustment, radio frequency automatic gain adjustment, and radio frequency gain-up adjustment.

9. A setup method for an apparatus for reproducing audio data recorded in an optical recording medium, the apparatus including an optical pick up that reads out audio data from an optical recording medium using a laser beam, a storage unit that accumulates at least one of a plurality of first digital audio signals obtained by performing a demodulation process on the audio data read-out, the setup method including executing a reproduction operation that includes performing the demodulation process on the audio data, generating a second digital audio signal, which is to be stored in the storing unit, from the audio data at a speed faster than a speed at which the first digital audio signal is outputted from the storage unit, and outputting the first digital audio signal from the storage unit, the setup method comprising:
executing an initial setup process when a reproduction instruction is received;
executing the reproduction operation after the initial setup process is finished;
suspending the generating the second digital audio signal when a predetermined amount of the first digital audio signals is accumulated in the storage unit, and executing an automatic adjustment process for components of the optical-recording-medium reproducing apparatus; and
releasing the suspending when the automatic adjustment process is finished, and resuming the reproduction process.

10. A computer-readable recoding medium that stores therein a computer program for setting up an apparatus that includes an optical pick up that reads out audio data from an optical recording medium using a laser beam, a storage unit that accumulates at least one of a plurality of first digital audio signals obtained by performing a demodulation process on the audio data read-out, the computer program for executing reproduction operation that includes performing the demodulation process on the audio data, generating a second digital audio signal, which is to be stored in the storing unit, from the audio data at a speed faster than a speed at which the first digital audio signal is outputted from the storage unit, and outputting the first digital audio signal from the storage unit, wherein the computer program causes a computer to execute:
executing an initial setup process when a reproduction instruction is received;
executing the reproduction operation after the initial setup process is finished;
suspending the generating the second digital audio signal when a predetermined amount of the first digital audio signals is accumulated in the storage unit, and executing an automatic adjustment process for components of the optical-recording-medium reproducing apparatus; and
releasing the suspending when the automatic adjustment process is finished, and resuming the reproduction process.
